(19) United States
(12) Patent Application Publication
(10) Pub. No.: US 2019/0100651 A1
(43) Pub. Date: Apr. 4, 2019

(54) Binder for manufacturing conglomerate products

(71) Applicants: Franco Pinelli, Pavullo nel Frignano (Modena) (IT); Max Canti, Gradara (Pesaro e Urbino) (IT)

(72) Inventors: Franco Pinelli, Pavullo nel Frignano (Modena) (IT); Max Canti, Gradara (Pesaro e Urbino) (IT)

(21) Appl. No.: 16/205,564

(22) Filed: Nov. 30, 2018

Related U.S. Application Data
(63) Continuation-in-part of application No. 14/347,043, filed on Mar. 25, 2014, now abandoned.

(30) Foreign Application Priority Data
Sep. 26, 2011 (IT) MO2011A000244

(51) Int. Cl. C08L 89/00

(52) U.S. Cl. CPC C08L 89/00; C08L 2205/16

(57) ABSTRACT

A binder for manufacturing conglomerate products includes a mixture of at least three components A, B, C. Component A is a natural soybean raw flour, a soybean concentrated protein, or an isolated soybean protein; component B is a low temperature calcinated magnesium oxide; and component C is a water-based solution of heptahydrate magnesium sulfate.

### FIELD OF THE INVENTION

The invention relates to a binder for manufacturing conglomerate products, and to a method of producing the binder.

### BACKGROUND OF THE INVENTION

In the manufacturing of particle-based or laminated products, binders are known to be used for binding together wood particles to form particle boards and panels, MDFs, plywood panels, oriented strand boards, blockboards, etc. that contain urea-formaldehyde, phenol-formaldehyde, or melamine-formaldehyde.

These materials bind the particles or layers to be laminated, when the particle-based products obtained using the above materials are subjected to the combined actions of pressure and heat.

A two-component polyurethane binder is also known to be used, which may spontaneously cure at room temperature or undergo accelerated curing by being subjected to the action of microwaves or radio-frequency, when it is already laminated but has not been pressed yet, with the laminated assembly being later subjected to a pressure action.

Generally, these binders are substantially divided into two classes, namely a class comprising those that form not water-resistant particle-based or laminated products and a class designed for water-resistant products.

The latter include the most widely used binders, phenol-formaldehyde and melamine-formaldehyde.

In addition, two-component or one-component polyurethane (diisocyanate) may be used, which is water-resistant but is less used for high cost reasons.

Binders that are not water-resistant are urea-formaldehyde and vinyl adhesives: the latter are less used due to their easy reversibility with moisture.

A further discrimination in the use of binders is given by their costs, and according to this parameter the less expensive binder is urea-formaldehyde, which is the most widely used for making interior furniture panels.

Conversely, those that ensure high water resistance have a very high cost, and include melamine-formaldehyde, phenol-formaldehyde, two- and one-component polyurethane.

The binders used in combination with formaldehyde, which is known to be a carcinogenic material, give off free formaldehyde, because the latter, in addition to being naturally contained in tree wood, is used in excess amounts for quicker curing of binders, to improve throughput of each production site.

The binders combined with two-component polyurethane, in addition to their above-mentioned high cost, are dangerous, in case of fire or upon disposal by burning, at the end of their life, because at a combustion temperature of 500° C. and more, they generate cyanide, a highly poisonous and paralyzing substance.

In prior art, no significant progress in developments of binders has been achieved for some time, and all the particle-based products derived from current industrial processes are mainly manufactured using formaldehyde as a binder.

In order to make other conglomerate particle-based products, in which no wood or paper is used, such as stone conglomerates, binders are used that comprise polyester resins in combination with styrene monomer, or acrylic resins.

Here again, polyester resins combined with styrene monomer are the most widely used binders, for their lower cost, in spite of their considerable environmental impact caused by styrene emissions (that are thought to be cancerogenic), with styrene being used in amounts exceeding stoichiometric amounts, to be combined with polyester for fluidizing and carrying the binder in the mixture.

A magnesium cementitious binder used for the construction of some conglomerate products in constructions is already known.

The magnesium cementitious binder (hereinafter briefly Sorel cement) is made from a mixture based on magnesium oxide, calcined at a low temperature, from magnesium chloride, from water and from inerts.

In addition, fiberglass meshes are positioned on surfaces of conglomerate products.

It is well-known from the literature that this kind of binder does not resist the boiling test, required for use of the Sorel cement outdoor or indoor of dump rooms (bathrooms, showers).

In addition, where the Sorel cement comes into contact with water, it releases hydrochloric acid which causes corrosion.

For this reason, in outdoor and indoor applications, where the humidity is present, silicate slabs or fiber-cement slabs with Portland cement are preferred.

### SUMMARY OF THE INVENTION

One object of the invention is to provide a binder based on magnesium oxide, magnesium sulfate and soybean flour/protein for the production of slabs conglomerated with organic particles as e.g. wood particles biomasses deriving from agricultural productions, hemp, wheat straw, rice straw, reeds, etc, and with inorganic particles as recycled minerals such as quartz, glass, calcium carbonate, chamotte, whose main characteristics are non-toxicity, oil-free composition, test boiling resistance for outdoor and indoor applications in humid environments, and fire resistance.

Products made by the binder of the invention can be re-used or re-cycled at the end of their life, as inert fillers to produce plastics (conglomerates of organic and inorganic particles) or as minerals to agricultural crops (conglomerates of organic particles) e.g. by treating them by a grinding.

Another object of the invention is to provide for a method for production of conglomerates that requires quick molding times thus satisfying production needs.

A further object of the invention is to provide for a method for making a binder that allows to make conglomerates to be used in construction field, in furniture field, in fire prevention, according to their specific physical/mechanic features.

In one aspect the invention a binder for making conglomerate products as defined in the features of claim 1 is provided for.

Therefore, the invention offers the following advantages:

providing a binder by which to make conglomerates to be used in constructions (also outdoor and in indoor humid environments) in the furnishing, in fire prevention;

making a binder to obtain conglomerates that at the end of their life cab be re-cycled or disposed of without producing pollution;

making a binder including natural and non-toxic components;

making a binder having a noticeably low cost with respect of known binders in proportion with the physical/mechanical features of the conglomerates made by the binder of the invention;

providing for a method for industrial production of organic/inorganic particles-based conglomerates having a high productivity.

### BRIEF DESCRIPTION OF THE DRAWINGS

Additional features of the invention will be more apparent upon reading of the description of a preferred embodiment of a binder for manufacturing of conglomerate products, as shown by way of an example without limitation in the annexed Figures wherein:

FIG. 1 is a picture of a microstructure of a first sample, or sample 1 of a mixture comprising 1.1 parts of component B, 1 part of component C and without component A, obtained using a scanning electron microscope Philips SEM XL20, at 100× magnification;

FIG. 2 is a picture of the first sample, or sample 1 of a mixture, obtained using the microscope of FIG. 1 at 30000× magnification;

FIG. 3 is a picture of a microstructure of a second sample, or sample 2 of a mixture comprising 0.27 parts of component A, 1.1 parts of component B, 1 part of component C, using the microscope of FIG. 1 at 100× magnification;

FIG. 4 is a picture of the microstructure of FIG. 3 at 20000× magnification;

FIG. 5 is a picture of a third sample, or sample 3, of a microstructure of a mixture comprising 0.27 parts of component A, 1.1 parts of component B and without component C, using the microscope of FIG. 1 at 10000× magnification;

FIG. 6A is a graph showing induction and growing phase of exothermic reaction of sample 1 of FIG. 1;

FIG. 6B is a graph showing induction and growing phase of exothermic reaction of sample 2 of FIG. 3;

FIG. 7 is a graph showing MgO intensity peak analysis in comparison between samples 1 and 2;

FIG. 8 is a table wherein influence of component A on water retention in samples 1 and 2 respectively is shown, also after dry treatment; and

FIG. 9 is a table wherein influence of component A on samples 1 and 2 respectively on induction and growing is shown, both under stable temperature and temperature increasing.

### DETAILED DESCRIPTION OF EMBODIMENTS OF THE INVENTION

The binder is obtained by mixing different amounts of at least three components, briefly designated by A, B, C hereinafter.

In detail, the component A is a natural soybean raw flour or a soybean concentrated protein or an isolated soybean protein, the component B is a low temperature calcinated magnesium oxide, the component C is a water-based solution of heptahydrate magnesium sulfate.

An amount of water and additives can be added to the above main components in order to improve viscosity of the binder and its biological duration.

Component B, i.e. the low temperature calcinated magnesium oxide, has a high degree of reactivity depending on the following factors:

Calcination temperature and specific area: the lower is the calcination temperature, the higher is reactivity owing to the larger specific area;

The magnesium oxide to be used is calcinated at a temperature of about 700-800° C. in a continuous and controlled process;

Granulometry and specific area: the finer is the granulometry, the higher is reactivity owing to the larger specific area;

The used magnesium oxide has a granulometry that in the 80% is lower than 45 microns and in the 100% is lower than 100 microns, but the skilled person can understand that the percentages of granulometry of the used oxide could also be different;

Content: the higher is the content of magnesium oxide, the lower is the amount of impurities that can affect the reactivity;

The used oxide has a content of magnesium oxide greater that 90% by weight.

Component C, i.e. the water-based solution of magnesium sulfate, has a density of 1270 kg/m³ (+/−10 Kg/m³) and is made of water and crystals of heptahydrate magnesium sulfate having a density of 980 Kg/m³ (+/−10 Kg/m³).

Component A, i.e. the soybean raw flour, is a commercial flour obtained by a grinding at a low temperature and therefore characterized by active not-denatured proteins by thermo-chemical-mechanical treatments and characterized by proteins (between 32-48% by weight), lipids (between 18-26% by weight), carbohydrates (between 11-17% by weight) and fibers (between 15-21% by weight).

The concentrated proteins and the isolated proteins have respectively between 70-75% by weight and between 90-95% by weight of not-denatured protein.

In order to solve the corrosion problems of Sorel cement in high humidity conditions, the replacement of the magnesium chloride by magnesium sulfate allows to protect iron structures, for the reason that sulfate ions SO₄(2) are less opened to corrosion of CL ions, as it can be read in: “XING SAINAN1, WU CHENGYOU, YU HONGFA, JIANG NINGSHAN, ZHANG WUYU, Research on A3 steel corrosion behavior of basic magnesium sulfate cement, IOP Conf. Series: Earth and Environmental Science 94 (2017) 012037.”

After mixing of the components A, B, C above, which are basic and essential components, it will be optionally added an amount of water to fluidify the binder and to reach a desired viscosity, preferably within 1000 and 6000 cP.

The preparation to obtain the binder of the invention, according to the method for its production, occurs by mixing intensively the components according to the following sequence: water, component C, component B and then component A.

Alternatively, components can be mixed according to the following sequence: water, component C, component A and then component B.

According to the invention, in a possible embodiment the mixture for obtaining the binder comprises 1.1 parts by weight of component B and 1 part by weight of component C, whereas component A may be in a range between 0.2 and 0.36 parts by weight.

For example, the binder may comprise kg 1.1 of component B, kg 1.0 of component C and between kg. 0.20 and kg. 0.36 of component A.

The method for preparing conglomerate manufactured products according to the invention comprises the following steps:

mixing intensively the binder obtained by previously mixing the components A, B, C, with organic and/or inorganic particles, thus obtaining a preparation;

spreading the preparation on a ribbon of a transporter designed to load the die of a press;

pressing the loaded preparation by heated pressing plates at a temperature higher than 90° C., thus obtaining conglomerate products; and

drying finally the conglomerate products in a worm air forced chamber.

The method according to the invention allows to make ready-to-use conglomerate products, without the need of further ripe inside stocking warehouses, how, on the contrary, it occurs for manufacture of conglomerate products obtained by a cold working process.

The effect of the magnesium sulfate (component C).

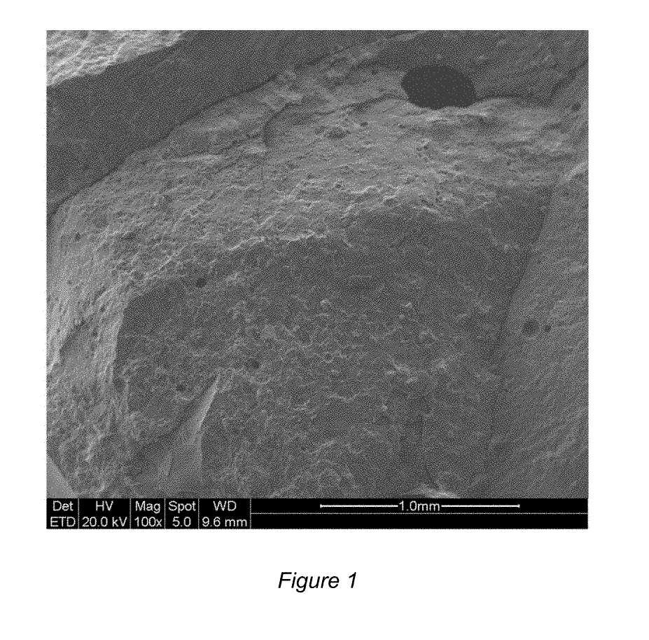

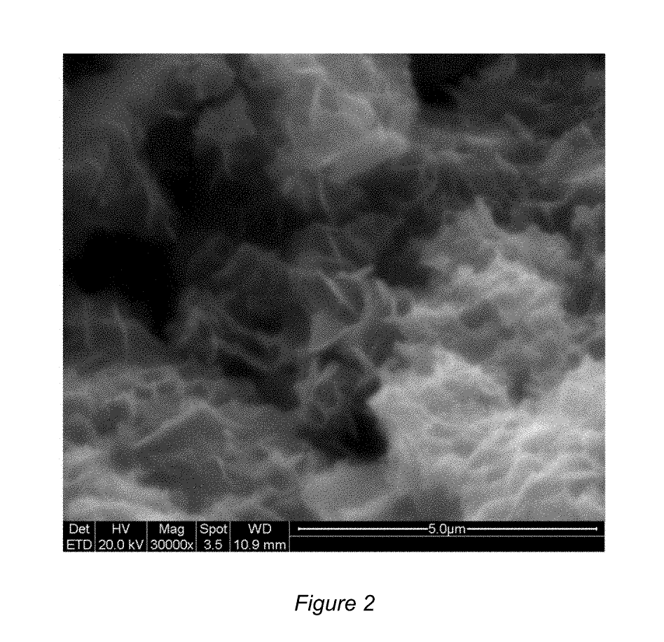

The S.E.M.'s images of samples of the binder, carried out by D.I.E.F., namely the Engineering Compartment of the University of Modena and Reggio Emilia, show that the presence of component C in the mixture, allows to reach the formation of laminar crystal needles of magnesium hydroxide that, reciprocally interlaced, make a well-structured matrix, thus mechanically resistant (see FIG. 1).

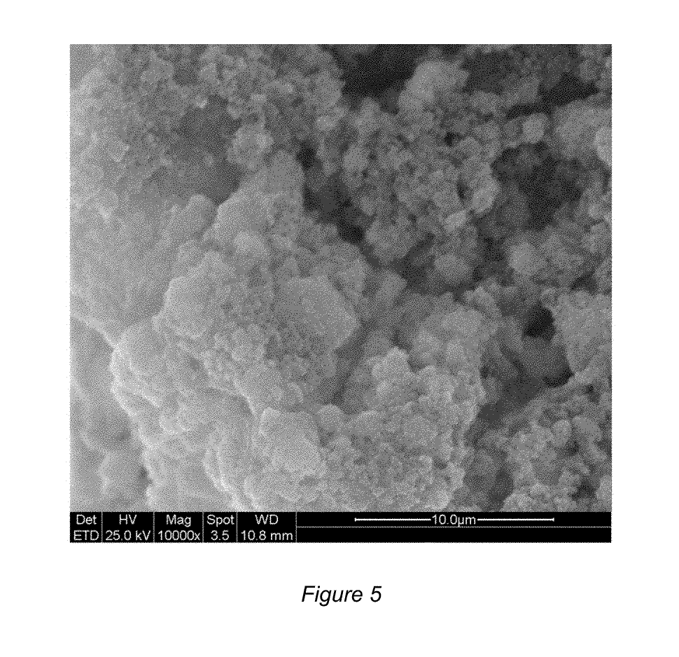

Contrarily, lacking component C in the mixture, the magnesium hydroxide is in form of nanometric not-structured particles and this involves the formation of a not-thick structure of the binder (see FIG. 5).

The effect of soybean flour/protein (component A).

The denaturation of the soybean flour/protein in the binder, occurs during the thermal pressing and drying steps of the method.

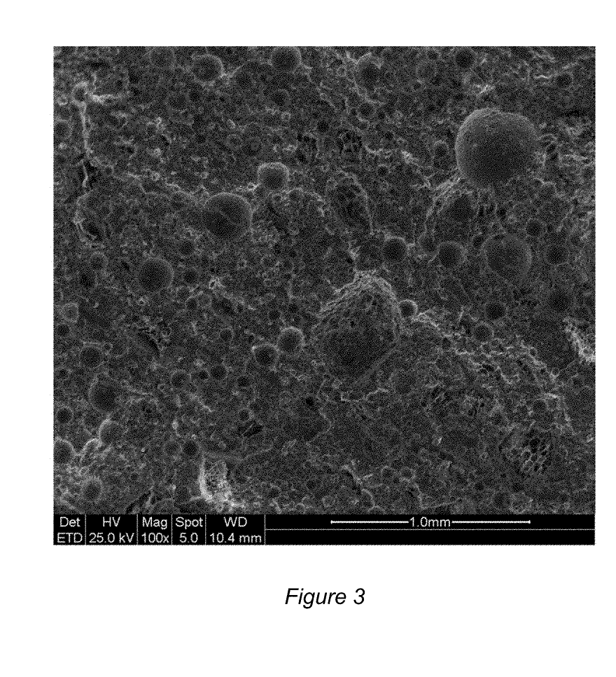

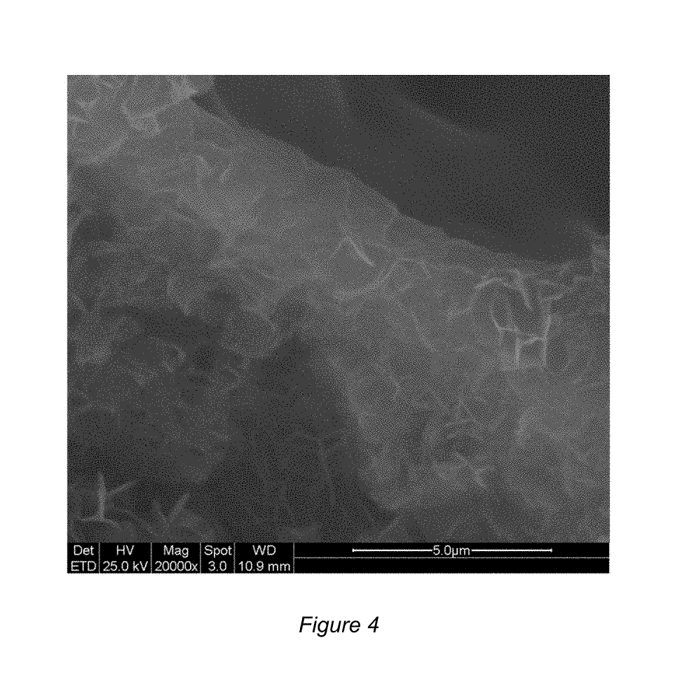

The denaturation creates micrometric pores which, as it can be seen in S.E.M.'s images, are rich zones for the nucleation of mineral phase of magnesium hydroxide of the binder of the invention, as it can be seen in FIGS. 3 and 4 wherein all components A, B, C are present.

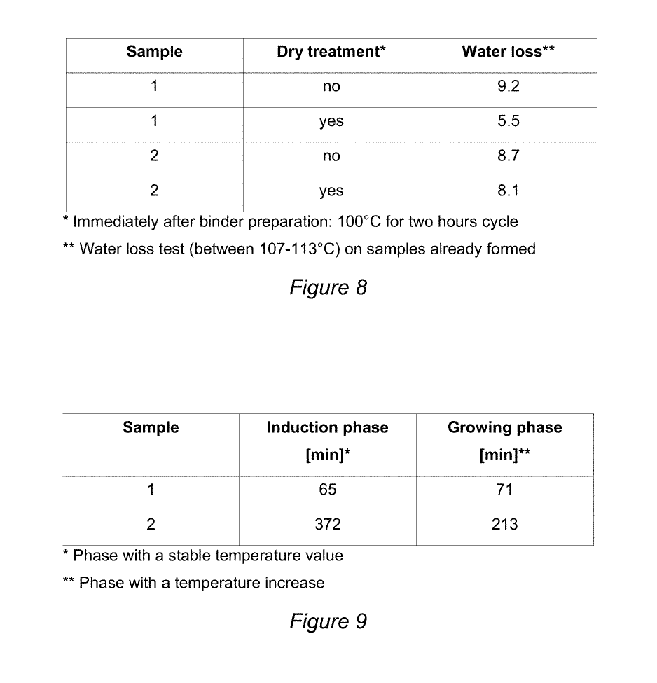

The thermo-gravimetric and thermo-differential analysis carried out by D.I.E.F. (see Table of FIG. 8) show the capability of the soybean flour to keep water in the conglomerate, even if subjected to a thermal production cycle carried out at a temperature up to 100° C.

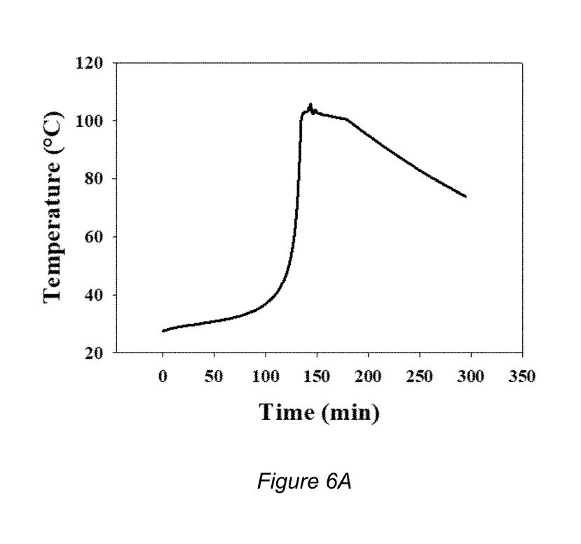

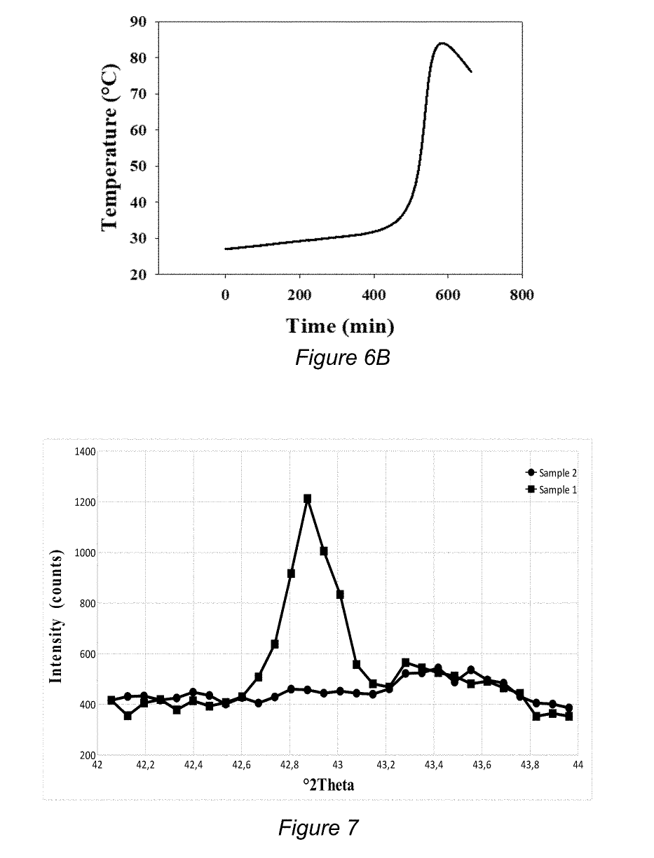

Therefore, by controlling the increasing of the temperature, the soy acts as a setting retardant (increasing of the so-called “induction period”) and thus allowing a controlled moulding process (see FIG. 6A-6B and table of FIG. 9).

In addition, the features of protein flour, namely to keep water in the binder, makes it available the water amount to hydrate the not-hydrated phases of magnesium oxide of the hardened mixture, thus obtaining a stabilization of the mixture.

The feature above can be seen in the XRPD analysis (see FIG. 7) wherein the soybean flour is present and wherein the peak intensity showing the not-reacted magnesium oxide in sample 2 wherein component A is present, is noticeably lower than intensity value in sample 1 wherein component A is lacking.

These features are essential because the presence of not-hydrated magnesium inside the conglomerates, invalidates their stability, giving rise to localized increasing of volume therein, up to 2.2 times with regard to the volume of the magnesium oxide.

An undesired effect of this localized increasing of volumes is the arising of uncontrolled structural deformations in the conglomerates.

The D.I.E.F. shows that the binder of the invention does not reveal foaming capacity in the binder of the invention.

As a matter of fact, the density value of the mixture of the binder, where measured before and after a strong mechanical shaking, shows similar values, i.e. 1.47 g/cm³ before mechanical shaking and 1.41 g/cm³ after mechanical shaking, thus demonstrating how the foaming effect of soy is not relevant.

The above disclosed invention was found to fulfill the intended objects.

The invention is susceptible to a number of changes and variants within the inventive concept.

Furthermore, all the details may be replaced by other technically equivalent parts.

In practice, any materials, shapes and sizes may be used as needed, without departure from the scope of the following claims.

The invention claimed is:

1. A binder for manufacturing conglomerate products comprising:
a mixture of at least three components A, B, C,
wherein component A is a natural soybean raw flour, a soybean concentrated protein, or an isolated soybean protein,
wherein component B is a low temperature calcinated magnesium oxide, and
wherein component C is a water-based solution of heptahydrate magnesium sulfate.

2. The binder according to claim 1, wherein the component B is a magnesium oxide calcinated at a temperature between 700° C. and 800° C.

3. The binder according to claim 1, wherein component C has a density of 1270 Kg/m³ (+/−10 Kg/m³).

4. The binder according to claim 1, wherein the component A has between 32% and 48% by weight of proteins, between 18% and 26% by weight of lipids, between 11% and 17% by weight of carbohydrates, and between 15% and 21% by weight of fibers.

5. The binder according to claim 4, wherein the component A is a low-temperature ground flour.

6. The binder according to claim 1, wherein the mixture comprises the following amounts: 1.1 parts by weight of component B, 1 part by weight of component C, between 0.20 and 0.36 parts by weight of component A, and from 0.6 to 0.8 parts by weight of water.

7. A method of producing a binder for manufacturing conglomerate products, comprising:
mixing in a mixing sequence at least three basic components A, B, and C, in a mixing apparatus to obtain a binder, wherein component A is a natural soybean raw flour, a soybean concentrated protein, or an isolated soybean protein, wherein component B is a low temperature calcinated magnesium oxide, and wherein component C is a water-based solution of heptahydrate magnesium sulfate;
adding water to fluidify the binder up to a desired value between 1,000 cP and 6,000 cP,
adding to the binder one or both of organic or inorganic particles, obtaining a preparation;
pressing the preparation in a pressing apparatus equipped with warm plates, obtaining a conglomerate product; and
drying the conglomerate product in a hot drying apparatus.

8. The method of claim 7, wherein the components A, B, C, and the water are mixed in the following sequence: water, then the component C, then the component B, and then the component A.

9. The method of claim 7, wherein the components A, B, C, and the water are mixed in the following sequence: the water, then the component C, then the component A, and then the component B.
